(19) United States
(12) Patent Application Publication
(10) Pub. No.: US 2009/0005247 A1
(43) Pub. Date: Jan. 1, 2009

(54) Dispenser and Methods for Dispensing Custom Garden Products

(75) Inventors: Brad A. Spiegel, Lake Forest, IL (US); Gilbert Tso, Chicago, IL (US); Dan Cotugno, Northbrook, IL (US)

Correspondence Address: MILLER, MATTHIAS & HULL, ONE NORTH FRANKLIN STREET, SUITE 2350, CHICAGO, IL, 60606, US

(73) Assignee: FLUID MANAGEMENT OPERATIONS, LLC, Wheeling, IL (US)

(21) Appl. No.: 12/144,313

(22) Filed: Jun. 23, 2008

Related U.S. Application Data
(60) Provisional application No. 60/946,297, filed on Jun. 26, 2007.

(51) Int. Cl. A01N 25/00

(52) U.S. Cl. 504/116.1

(57) ABSTRACT

An apparatus for diagnosing a plant ailment and providing a formulation to address the plant ailment is shown and described along with a method of identifying a plant ailment, dispensing a formulation for the ailment and for applying the formulation to the plant are disclosed. The formulation dispenser is a multiple-component liquid and powder material dispenser with multiple pump types and reservoirs or canisters. All of the pumps are controlled by a central controller which also preferably includes substantial memory for a database containing a library of formulations associated with particular plant ailments. Samples of the sick plants may be scanned or digital photographs downloaded into the memory for diagnosis. Experts can be consulted over the internet or telephone for assistance in identifying an appropriate formulation. A limited quantity of the formulation is prepared for a single application and deposited in a recyclable container. The entire formulation is intended to be applied and the container disposed of thereby eliminating the presence of hazardous materials in the consumer's garage or garden shed. The dispensed formulations may be in granular, liquid or concentrate form.

### BACKGROUND

1. Technical Field

An improved dispensing system and a process for dispensing various liquid and powder formulations for plant, lawn and garden care are shown and described. More specifically, a method of diagnosing a plant illness, deficiency or infestation in combination with an improved dispensing system for combining multiple ingredients in the forms liquids, slurries and/or powders for a plant remedy such as a fertilizer or insecticide are disclosed.

2. Description of the Related Art

In general, it is known that damage to a plant may be caused by a variety of sources including insects, funguses, or by a deficiency or overexposure to specific fertilizer elements such as manganese, calcium, magnesium, etc. Insects and funguses can often be identified visually. Specifically, insects, funguses and molds may be seen with the naked eye or microscope and certain deficiencies or excesses of an element or nutrient can be visibly detected in predictable forms such as fading in the plant, a position of the fading in the whole plant and the leaf, grass blade or the like.

For example, if iron-deficiency disease is caused in a tomato plant, the color of the upper leaves initially change from green to light green leaving green veins in the leaves. Thereafter, the entire tomato leaf turns yellowish-green as the disease progresses. When a tomato plant has a magnesium deficiency, a tomato leaf gradually changes from green to light green, with dead spots appearing in veins of the lower leaves. Also, the leaves in the vicinity of the tomato fruit turn yellow with scattered brown spots. When a tomato plant has been exposed to excessive amounts of manganese, the veins of the lower leaves will be chocolate-colored with tiny spots.

All that is needed to detect the above conditions is a visual confirmation, preferably in an early stage of infestation or disease. However, most home gardeners lack the requisite knowledge of plant diseases for the wide variety of plants found in most gardens and the experience required to make the correct diagnosis of a plant ailment. An oral description of a plant ailment to a proprietor of a lawn and garden store is problematic as many store personnel also lack the requisite knowledge and experience and, quite often, the description provided by the gardener is inaccurate or insufficient.

One problem associated with lawn and garden products in general is that different formulations are effective for different plant ailments. Thus, a retailer is required to maintain a large variety of formulations in stock to satisfy consumer needs. Often these formulations are hazardous materials and state or federal rules govern their disposal. Further, the consumer will typically buy a formulation for a particular plant ailment, not use the entire product and the partially-filled container will take up space in the consumer's garage. Over the years, several or even more of these partially-filled containers accumulate in the garage until they are disposed of. Further, the materials are typically hazardous and therefore may be illegal to throw away in a municipal garbage system. Thus, the conscientious consumer must take these old products to a proper waste disposal site and compliance with this requirement is most likely relatively low.

Further, as plant technology advances, the formulations for different ailments will change. Often manufacturers will combine remedies in a single formulation to enhance the appeal of the product to the consumer. This can have an adverse effect on the plant if it has only a single ailment, yet receives a remedy directed at numerous ailments. Such combinations of products may also adversely effect the environment.

Therefore, there is a need for an improved system and method for formulating lawn and garden products at a point of sale. If a plant could be properly diagnosed, and the proper remedy identified, a single formulation in an appropriate quantity could be provided to the consumer, thereby improving the treatment of the plant, reducing the need to replace diseased plants, reducing waste and reducing the adverse affects of lawn and garden products on the environment.

While the following discussion will be directed toward the formulation of lawn and garden products, it will be noted that this application and the dispensers and methods of dispensing disclosed herein are applicable to various fields beyond that of lawn and garden products and this disclosure generally applies to formulations which consist of relatively large quantities of bulk ingredients that may be added by weight with a high degree of speed and relatively low degree of precision and relatively small quantities of other ingredients, in either liquid or powder form that must be added by volume or weight with greater precision.

### SUMMARY OF THE DISCLOSURE

In satisfaction of the aforenoted needs, an improved method for determining a plants ailment and dispensing of formula as a remedy for the plant ailment is disclosed. The method utilizes an apparatus maintained in a retail store environment.

One disclosed method comprises initially diagnosing the plant ailment. This may be done by the consumer at his or her home or the consumer may bring a sample to the retail store. As an alternative, the consumer may take a digital photograph or a conventional photograph and bring or transmit the photograph to the store. At the store, the consumer alone, or with the assistance of a store employee, can search a database contained within the memory of the disclosed dispensing apparatus to identify the particular plant ailment. This database search may include downloading a photograph of the plant, having a sample of the plant or answering a questionnaire. Once the plant ailment is identified, software in the controller can be utilized to determine an appropriate formulation that will serve as a remedy for the ailment. Then, with input from the consumer, the required quantity of the formulation is determined. A container is then disposed on a scale of the apparatus and then dispensing begins. Preferably, dispensing begins with one or more of the bulkiest ingredients in the container and the dispensing are performed on a weight or gravimetric basis. Then, dispensing of the lesser ingredients or ingredients of smaller quantities is performed by volume, by weight or by combination of volume and weight. Finally, the remainder of any bulk ingredients is added to the container and the container is sealed.

If the formulation is a liquid formulation, no mixing is typically required. If the formulation is a concentrate or fixed slurry that would be applied with a garden hose, mixing may be required and an appropriate shaking apparatus or mixing apparatus may be provided. If the formulation is a granular or dry formulation, a mixing chamber or agitator may be provided with the apparatus to insure suitably mixing of the dry ingredients before they are deposited in the container.

In a refinement, the container is a flexible container.

In a refinement, liquids and powders can be dispensed gravimetrically, volumetrically or a combination of gravimetrically and volumetrically.

In a refinement, the determining of appropriate formulation comprises browsing a library of plant ailment descriptions stored in the memory of the controller of the apparatus, identifying the plant ailment and wherein the software identifies the appropriate formulation automatically.

In a refinement, the determining of an appropriate formulation comprises communicating with an expert over the internet. In a further refinement of this concept, the expert is communicated over the internet using voice over internet protocol (VOIP) technology. In still a further refinement of this concept, the determining of the appropriate formulation comprises sending the expert a digital photograph of the plant ailment.

In another refinement, a digital photograph of a plant ailment is taken and downloaded into the controller of the dispensing apparatus and the photograph is compared against a library of photographs stored in the memory of the controller and wherein each stored photograph is associated with a particular formulation.

Throughout this specification, a plant ailment can be an insect infestation, a fungus infestation, a bacteria infestation or infection, a mold infestation, a nutrient deficiency, a nutrient over exposure, exposure to a pollutant or poison, over exposure to sunlight or under exposure to sunlight.

In a refinement, the appropriate quantity of the formulation is determined at the point of sale and the package contains instructions to use the entire contents of the package, and for discarding the package in the trash. Thus, in one preferred embodiment, it is intended that there be no leftover or remainder of chemicals or formulations.

An improved gravimetric and volumetric liquid and powder dispenser is disclosed for preparing lawn and garden products at a point of sale. The dispensing system comprises a scale which is linked to a controller. The controller is also linked to a plurality of valves and pumps. The dispensing system also includes a plurality of reservoirs of liquid and/or powder materials. Each reservoir is connected to its own pump and vice versa. Liquid bulk ingredients may be dispensed through a two stage valve and other additives may be disposed by more accurate nutating pumps for powder pumps. Powder or granular bulk ingredients may be dispensed with screw conveyor or powder pumps. The bulk ingredients can be dispensed sequentially and gravimetrically using signals from the scale to the controller and from the controller to the two stage valves for a relatively fast dispense of the bulk liquid ingredients. Screw conveyors could be used for bulk dryer powder ingredients. Other additives may be dispensed volumetrically by controlling the nutating pumps with signals from the controller or gravimetrically using the scale, controller and powder pumps in the case of powders.

In a refinement, the dispensing system also comprises a proportional control that is linked to the controller and each of the bulk material pumps. The controller sends signals to the proportional control to control the output of each bulk material pump, either directly at the bulk material pump or by way of a control valve.

In a further refinement, the controller sends signals to the proportional control to increase or decrease the output of one of the bulk material pumps at a time in response to signals received at the controller from the scale indicating the amount of the particular bulk material that passed through a control valve or that is deposited in the container.

In another refinement, each bulk reservoir houses a different bulk material. Similarly, in another refinement, each additive reservoir houses a different ingredient.

In another refinement, the scale of the dispensing system comprises a horizontal surface for supporting the container to be filled with bulk ingredients and additives. In this refinement, the horizontal surface comprises indicia or upwardly protruding indicators to facilitate the centering of containers of different sizes under the manifold or ingredient outlet.

In another refinement, the bulk reservoirs of the dispensing system are located remotely from the manifold by a distance of greater than 15 feet and the nutating pumps and powder pumps are disposed in close proximity to the manifold, within about 10 feet.

An improved method for dispensing a plant formula comprising a plurality of bulk ingredients and a plurality of other ingredients used in lesser amounts is also disclosed. The method which utilizes a single dispensing apparatus. The method comprises placing a container on a scale; dispensing one or more bulk ingredients into the container by weight; dispensing additional ingredients into the container by volume; dispensing powdered materials into the container by weight.

In a refinement, such a dispensing method can be carried out using the dispensing systems disclosed above. In a further refinement, one or more additional ingredients may be added by hand.

Similarly, an improved method for dispensing a liquid plant formula is disclosed wherein the liquid formula comprises a plurality of liquid bulk ingredients and a plurality of liquid ingredients and powder ingredients. Again, a single dispensing apparatus is utilized and the method comprises: placing a container on a scale; dispensing one or more bulk ingredients into the container by weight; dispensing any liquid ingredients into the container by volume; and dispensing any powder ingredients into the container by weight.

The dispensing systems and methods disclosed herein may be applicable beyond the lawn and garden industry, such as cosmetics, beverages, dyes, inks, liquid nutritional products, medicinal products and other liquid formulations that include relatively large quantities of bulk ingredients and relatively small quantities of colorants or other additives.

Other advantages and features will be apparent from the following detailed description when read in conjunction with the attached drawings.

### BRIEF DESCRIPTION OF THE DRAWINGS

The disclosed dispensing systems and dispensing methods are described more or less diagrammatically in the accompanying drawings wherein:

FIG. 1 is a perspective view of a dispensing system made in accordance with this disclosure;

FIG. 2 is a schematic illustration of the dispensing system disclosed in FIG. 1 further illustrating the relationships between the controller, the proportional control and the bulk reservoirs, the powder pumps and liquid pumps connected thereto in the disclosed modular cabinetry;

FIG. 3 is a schematic illustration of one or more disclosed methods for identifying a remedy and dispensing the correct quantity of a formulation for the application by the consumer.

It should be understood that the drawings are not necessarily to scale and that the embodiments are sometimes illustrated by graphic symbols (e.g., the pneumatic pumps), phantom lines, diagrammatic representations and fragmentary views. In certain instances, details which are not necessary for an understanding of this disclosure or which render other details difficult to perceive may have been omitted. It should be understood, of course, that this disclosure is not limited to the particular embodiments and methods illustrated herein.

### DETAILED DESCRIPTION OF THE PRESENTLY PREFERRED EMBODIMENTS

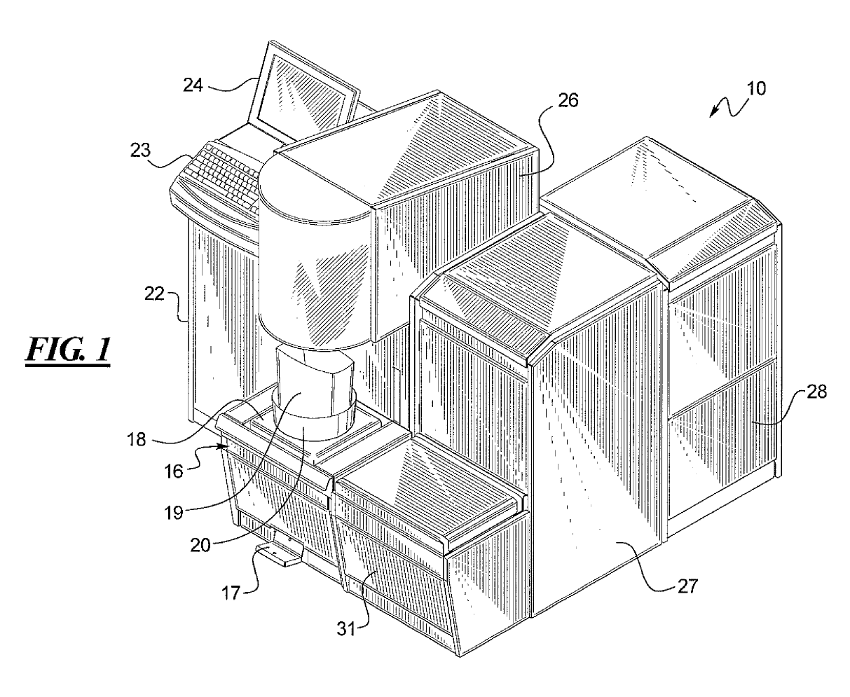

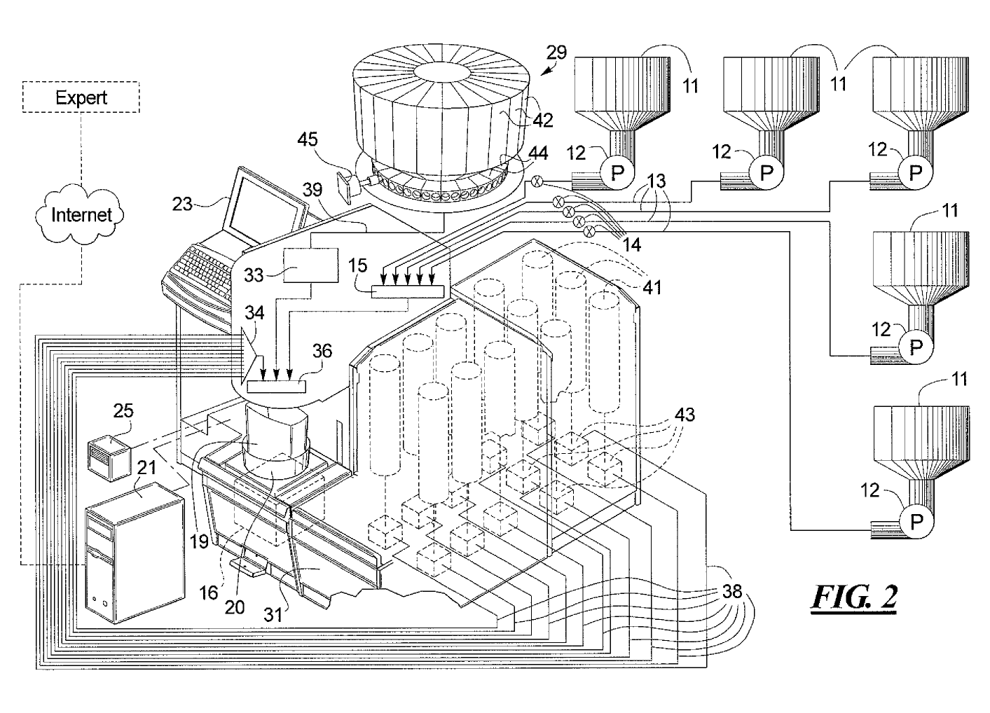

FIG. 1 illustrates, in part, a dispensing system 10 made in accordance with this disclosure. FIG. 1 is only a partial illustration because, as illustrated in FIG. 2, the dispensing system 10 also includes a plurality of bulk reservoirs 1, pumps 12 which are connected to the individual bulk reservoirs 11 and conduits 13 linking the bulk reservoirs 11 to the valves 14 and bulk material manifold 15, all shown in FIG. 2.

Returning to the dispensing system 10 shown in FIG. 1, the system 10 includes a scale 16 which may be adjusted vertically by way of the foot pedal 17 so that the horizontal surface 18 may be raised or lowered to accommodate a larger or smaller flexible container than the one shown at 19 in FIG. 1. A supporting tray 20 or other device may be used to hold the flexible container 19 in place during the fill. The container or sack 19 is intended to disposable in a municipal garbage system and should not require any special disposal effort such as those required for some pesticides. With a carefully controlled quantity, the entire contents of the container should be used with no leftovers or residual ingredients. As a result, problems associated with disposal of chemicals, such as pesticides or fertilizers are avoided.

As shown in FIG. 2, the scale 16 is linked to a controller 21 which is housed in the cabinet 22 disposed below the keyboard 23 and monitor 24 as shown in FIG. 1. Referring to FIGS. 1 and 2 together, it will also be noted that a proportional control or a proportional controller 25 may also be linked to the controller 21 and disposed in the cabinet 22. It will be noted that the cabinet 22 is not fixedly connected to the center cabinet 26 or the canister cabinets 27, 28. As indicated in FIG. 2, the center cabinet 26 may house a powder dispenser 29, but the powder dispenser 29 may be housed elsewhere, such as in the side cabinets 27 or 28. Thus, the arrangement shown in FIG. 1 but one arrangement for the dispenser 10 and the cabinets 27, 28 can be disposed on either side of the cabinets 26 and 22 or behind the cabinets 26 and 22. Further, the container support 31 is not connected to the scale 16 it may be eliminated or moved to either side of the scale 16.

In addition to the powder dispenser 29, the center cabinet 26 may also house various valves 14 leading to the bulk material reservoirs 11, one or more manifolds 15, 33 and 34, a mixing station 36 and various conduits 13, 38, and 39 leading from the reservoirs 11, liquid ingredient canisters 41 and powder ingredient canisters 42 disposed within the cabinets 26, 27, 28 as shown schematically in FIG. 2.

The liquid ingredient canisters 41 are preferably coupled to nutating pumps 43 because of their speed, controllability and accuracy. The control and operation of nutating pumps is disclosed and explained in commonly assigned U.S. Pat. Nos. 6,749,402, 6,540,486 and 6,398,513, which are incorporated herein by reference. The control and operation of gravimetric and volumetric dispensers like that shown in FIGS. 1-2 is further illustrated in commonly assigned U.S. Pat. Nos. 7,147,012 and 6,991,004, which are incorporated herein by reference. The control and operation of powder pumps and dispensers is further explained in U.S. Pat. No. 7,143,573 and U.S. Pat. App. Pub. No. 2007/0084520, which are incorporated herein by reference.

In operation, when dispensing a formula into the container or bag 19 that comprises one or more bulk ingredients that constitute the majority of the finished formulation and a plurality of additive materials that constitute a minority of the finished formulation, a preferred method for operating the dispensing system 10 is as follows.

First, the system 10 will begin first with the transport of bulk material from one of the reservoirs 11 through its respective conduit 13 and to its corresponding valve 14. If the material is liquid, the bulk material is delivered to the two step valve 14 under pressure by way of its corresponding pump 12. If the bulk material is a powder or granular material, the pump is an auger or screw-type conveyor as illustrated in U.S. Pat. No. 7,143,573 and U.S. Pat. App. Pub. No. 2007/0084520.

Thus, a dispensing system 10 begins by opening one of the valves 14 or activating one of the pumps 12 by way of a signal from the controller 21 thereby allowing bulk material to pass through the valve into the container 18. The proportional control 25 may be utilized in one of two different ways. The proportional control 25 may control the speed of the pump 12 being utilized to modulate the flow of bulk material from its bulk reservoir, through its respective conduit 13 to its respective valve 14 to thereby provide a relatively slow initial flow though the valve 14. Then, after the initial flow is established, the proportional control 25 may increase the speed of the pump 12 being utilized to increase the flow through the valve 14. Another method would include the use of one or more control valves disposed in the manifold 15 which could be linked to the proportional control 25 or directly linked to the controller 21 for that matter to modulate the initial flow of bulk material to the container 19. Either way, the proportional control 25 may be controlled by the controller 21.

As the first bulk material enters the container 19, the scale 16 registers the weight chain and transmits a stream of signals to the controller 21. As the amount of bulk material deposited in the container 19 approaches the desired amount for that bulk material, the proportional control 25 may then slow the flow of bulk material through the valve 14 or reduce the speed of the pump 12. As the desired amount is reached, the controller 21 then sends a signal to close the valve 14 or shut of the pump 12 that is currently being utilized.

This process may be carried out for one or more of the bulk ingredients being delivered from the bulk reservoirs 11. In a preferred scheme, one or more bulk ingredients to be added to the container 19 from the bulk reservoirs 11 is “saved” until after the addition of the lesser ingredients from the canisters 41 or 42. By utilizing this scheme, the smaller volumes of the ingredients are added between layers of bulk material to facilitate later mixing of the formulation in the container 19. For dry or granular formulations, an additional mixing station 3 may be needed to mix the material before they are deposited in the sack 19.

With at least part of the bulk ingredients from the reservoirs 11 added to the container 19, the controller 21 will then sequentially operate one or more of the liquid pumps 43 or powder pumps 44 for adding the other ingredients to the container 19. Operating sequentially or consecutively, the nutating pumps 43 draw fluid from their respective canisters 41 and pump the fluid though its respective conduit line 38 to the manifold block 34. Similarly, the powder or screw-type pumps 43 draw powder from their respective canisters 42 and pump the powder though its respective conduit line 39 to a collector 33 and possible the mixing station 36. After the addition of the additive materials from the canisters 41, 42 by way of the pumps 43, 44 and conduits 37, 39, additional bulk ingredients are added on top of the additive materials from one or more of the bulk reservoirs 11 in the manner described above to facilitate mixing. Again, bulk ingredients from the reservoirs 11 are added gravimetrically, that is by weight using a feedback control loop incorporated into the software used by the controller 21 which operates the proportional control 25 and directly or indirectly operates the pumps 12 and/or the valves shown at 14. The nutating pumps 43 dispense volumetrically while the powder pumps 44 dispense gravimetrically like the pumps 12, but with a greater concern for accuracy as illustrated in US 2007/0084520. A motor 45 for operating the powder pumps 44 is shown. Each nutating pump 43 would also include its own motor.

A key advantage to the dispensing system 10 shown and described here is that bulk ingredients and additive materials may be dispensed into a flexible container using a single system. Further, as shown in FIG. 2, the larger reservoirs 11 of bulk material may be stored at a remote location from the dispensing apparatus 10. For example, bulk material may be stored in large hoppers 11 disposed outside of the retail environment or outside of a shop or factory floor thereby conserving valuable floor space. The modular design of the cabinetry 26, 27, 28 for the ingredient canisters 41, 42 enables the design of a system with as few as three or four ingredient canisters 41, 42 to as many as thirty six or more ingredient canisters 41, 42 as shown in FIG. 2. Further, by providing a method of dispensing whereby at least a portion of the bulk ingredients are added to the container 19 first prior to the additive materials and then followed by addition of further bulk ingredients, improved mixability is achieved.

The disclosed method eliminates waste by having the consumer buy single formulations in fixed volumes of a prescribed quantity. Thus, it is intended that they leftover materials be stored in the consumer garage or shed. For the retailer, floor space is conserved, so smaller retailers can offer an extensive range of formulations in multiple strengths using the disclosed dispenser. The formulations may be disclosed as concentrates for dilution at home or sold as ready-to-use formulations by adding water or solvent at the store.

In a further refinement, software in the database will prevent harmful combination of ingredients. Optionally, the apparatus can track, via RFID, barcode or other indicia identifying the manufacturing lot of each individual ingredient for appropriate safety labeling. Thus, traceability of all ingredients in the finished product can be provided for.

The controller of the apparatus may also include software for an automated refill system and communicate to the consumer when additional formulation may be needed. Controller may also be programmed with software that is updated for common pest and environmental conditions in specific regions of the country. The software may also recognize repeated conditions presented by other consumers or by expert plant pathologists or other experts in communication with the apparatus. Access to the wizard software may also be provided to consumers for at home diagnosis and selection of the store location where the formulation would be sent for dispense for later pickup, or delivery directly to the consumer's home.

The quantity of the formulation provided to the consumer by the machine would be dependent on the size of the plant, the quantity of plants, the size of infestation, time of year, time since last application and/or estimated area to be covered. Material data safety sheet (MSDS) documentation can be printed by the apparatus to the container as a label. As the apparatus will most likely be connected to the internet, remote monitoring of the apparatus can be provided. Compilation of consumer data and e-mail reminders may also be provided for. Notification to consumers of potential adverse pests or conditions in a general area may also be inacted.

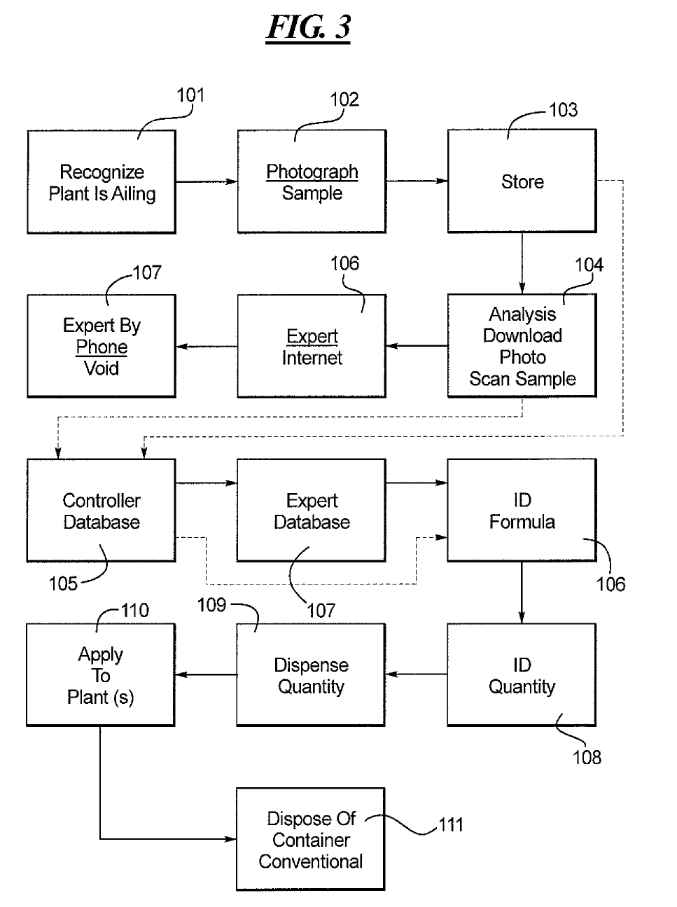

FIG. 3 is a general schematic illustrating the disclosed methodology. At 101, the consumer recognizes that there is a problem; that one or more plants is in ailment in the form of infestation, disease, etc. At 102, consumer either photographs a sick plant, selects a sample or provides a detailed description to a store employee or to the input terminal 23 of the apparatus 10. At 104, an analysis or diagnosis is either made at the apparatus 10 or by consulting the controller database at 105 or expert advice is sought immediately at 106 over the internet or at 107 by voice contact. Often, database stored in the controller 21 will be adequate and the formula can be identified at 106 for application to the sick plants. At this stage, however, expert advice may be sought at 107 over the internet or telephone. Consumer input is used at 108 to identify an appropriate quantity for dispensing, which is dispensed at 109 and applied by the consumer to the sick plants at 110. After the initial application, the container should be empty and can be disposed at 111.

While only certain embodiments have been set forth, alternatives and modifications will be apparent from the above description to those skilled in the art. These and other alternatives are considered equivalents and within the spirit and scope of this disclosure and the appended claims.

What is claimed:

1. A method for determining a plant ailment and dispensing a formula as a remedy for the plant ailment using an apparatus, the method comprising:
detecting a plant ailment,
determining an appropriate formulation for the plant that will serve as a remedy for the ailment,
determining a needed quantity of the formulation,
placing a flexible container on a scale,
dispensing one or more bulk ingredients into the container by weight;
dispensing one or more additional ingredients into the container by volume;
dispensing any remaining bulk ingredients into the container by weight;
sealing the container.

2. The method of claim 1 wherein the determining of the appropriate formulation comprises browsing a library of plant ailment descriptions stored in a memory of a controller of the apparatus.

3. The method of claim 1 wherein the determining of the appropriate formulation comprises communicating with an expert over the internet and through a controller of the apparatus.

4. The method of claim 3 wherein the determining of the appropriate formulation comprises communicating with the expert using VOIP.

5. The method of claim 3 wherein the determining of the appropriate formulation comprises taking a digital photograph of the plant and transmitting the photograph to the expert.

6. The method of claim 1 wherein the determining of the appropriate formulation comprises:
taking a digital photograph of the plant,
comparing the photograph against a library of photographs stored in a memory of a controller, wherein each stored photograph in the library is associated with a formulation.

7. The method of claim 1 wherein the ailment is one of a nutrient deficiency, a nutrient overexposure, a fungus infestation, a bacteria infestation, a mold infestation or an insect infestation.

8. The method of claim 1 wherein the ailment is an insect and the determining of a formulation comprises determining of an insecticide.

9. The method of claim 1 wherein the container is recyclable.

10. An apparatus for dispensing a plant formulation, the apparatus comprising:
a controller, the controller having a memory with a library of formulations stored therein and at least one plant ailment associated with each formulation, the memory of the controller further comprising a search engine for searching the memory and a program for determining required quantities of the formulations,
an input terminal linked to the controller for inputting a description of a plant ailment, activating a search, determining an appropriate formulation and calculating a required quantity of the appropriate formulation,
a plurality of pumps and a plurality of reservoirs of ingredients,
the controller being linked to pumps for sequentially activating the pumps and dispensing the ingredients of the formulation into a container,
a scale linked to the controller for dispensing at least some of the ingredients by weight.

11. The apparatus of claim 10 wherein the user can browse the library using the input terminal.

12. The apparatus of claim 10 wherein the controller is linked to the internet and the user communicate with an expert over the internet.

13. The apparatus of claim 12 wherein the controller is linked to the expert with VOIP.

14. The apparatus of claim 10 wherein the apparatus comprises a digital camera for obtaining an image of the plant.

15. The apparatus of claim 10 wherein the apparatus comprises a scanner for obtaining an image of the plant.

16. The apparatus of claim 10 wherein the library comprises a photograph of a plant with an ailment associated with each formulation.

17. The apparatus of claim 10 wherein the ailment is one of a nutrient deficiency, a nutrient overexposure, a fungus infestation, a bacteria infestation, a mold infestation or an insect infestation.

18. The apparatus of claim 10 wherein the ailment is an insect and the appropriate formulation comprises an insecticide.

19. The apparatus of claim 10 wherein the container is recyclable.

20. A method for determining a plant ailment and dispensing a formula as a remedy for the plant ailment using an apparatus, the method comprising:
detecting a plant ailment,
determining an appropriate formulation for the plant that will serve as a remedy for the ailment including at least one step selected from the group consisting of communicating with an expert over the internet and through a controller of the apparatus, browsing a library of plant ailment descriptions stored in a memory of a controller of the apparatus, taking a digital photograph of the plant and transmitting the photograph to the expert, comparing a digital photograph of the plant against a library of photographs stored in a memory of a controller,
determining a needed quantity of the formulation,
placing a flexible container on a scale,
dispensing one or more bulk ingredients into the container by weight;
dispensing one or more additional ingredients into the container by volume;
dispensing any remaining bulk ingredients into the container by weight; sealing the container.
